(19) United States
(12) Patent Application Publication
(10) Pub. No.: US 2018/0171237 A1
(43) Pub. Date: Jun. 21, 2018

(54) TERNARY CATALYST SYSTEM FOR REDUCTION OF ACIDS IN A LIQUID HYDROCARBON

(71) Applicant: Chevron U.S.A. Inc., San Ramon, CA (US)

(72) Inventors: Zhen Zhou, Fairfield, CA (US); Lin Li, Richmond, CA (US); Shabbir Husain, Houston, TX (US)

(21) Appl. No.: 15/383,073

(22) Filed: Dec. 19, 2016

(51) Int. Cl. C10G 29/16; B01J 23/02; B01J 23/745

(52) U.S. Cl. CPC C10G 29/16; C10G 2300/203; B01J 23/745; B01J 23/02

(57) ABSTRACT

A process for reducing total acid number (TAN), comprising: contacting, without hydrogen addition, a liquid hydrocarbon having a high initial TAN with a ternary catalyst comprising titanium-oxide, a metal promoter, and a porous support; wherein the contacting occurs over a short time or at a defined LHSV, and at a low contacting temperature, and wherein the contacting reduces the initial TAN by at least 20%. Also, a new ternary catalyst that reduces the TAN, wherein the ternary catalyst has a molar ratio of titanium to metal from the metal promoter that is greater than 3:1.

### TECHNICAL FIELD

This application is directed to a process for reducing a Total Acid Number (TAN) of a liquid hydrocarbon, and to a new ternary catalyst composition that is used for reducing the Total Acid Number of the liquid hydrocarbon.

### BACKGROUND

Corrosion is a critical issue when refineries process crude oils having high TAN. The corrosion can be attributed to a high concentration of naphthenic acids, and other acidic species in the liquid hydrocarbon. Processing high TAN crudes can result in high equipment maintenance costs, expensive metallurgy, and refinery outages when equipment failures occur. Improved processes and equipment are needed for reducing acids in high acid crudes and other liquid hydrocarbons having high TAN.

Crude oils having high TAN are often sold at a discount, making them less valuable to crude oil producers.

Processes and equipment for acid removal in crude oils have included caustic washing, adsorption, hydrotreating, and acid extraction, but with various disadvantages. Earlier processes using metal titanate catalysts have also been tried, but further improvements are needed.

### SUMMARY

This application provides a process for reducing a TAN of a liquid hydrocarbon, comprising contacting, without addition of a hydrogen, the liquid hydrocarbon having an initial TAN from 0.5 to 150 mg KOH/g with a ternary catalyst comprising a titanium-oxide, a metal promoter, and a porous support; wherein the contacting occurs over less than two hours or at a Linear Hourly Space Velocity (LHSV) from 0.5 hr⁻¹to 10 hr⁻¹, wherein the contacting occurs at a contacting temperature from 200° C. to 300° C., and wherein the contacting reduces the initial TAN by at least 20% in a contacted hydrocarbon.

This application also provides a new ternary catalyst that reduces a TAN of a liquid hydrocarbon at a contacting temperature from 200° C. to 300° C., comprising: a titanium dioxide; a metal promoter that is not an oxide, wherein the metal promoter comprises an iron, a calcium, or a combination thereof and a porous support comprising a silica, an alumina, a silica-alumina, or a mixture thereof; wherein the ternary catalyst has a molar ratio of a titanium to a metal from the metal promoter that is greater than 3:1.

The present invention may suitably comprise, consist of, or consist essentially of, the elements in the claims, as described herein.

### BRIEF DESCRIPTION OF THE DRAWING

FIG. 1 is a block diagram illustrating an example of a TAN reduction unit utilizing a ternary catalyst of this invention.

### GLOSSARY

A “mineral crude oil” is any naturally-occurring flammable mixture of hydrocarbons found in geologic formations, such as rock strata.
“Total Acid Number” (TAN) refers to the amount of KOH, in milligrams, that is required to neutralize one gram of a test sample. TAN is determined by Test Method A of ASTM D664-11ae1, Standard Test Method for Acid Number of Petroleum Products by Potentiometric Titration.
“Naphthenic acid” refers to the carboxylic acid content in a hydrocarbon, and can include alkyl substituted acyclics, fatty acids, aromatic acids, carbazoles, isoprenoid acids, and mixtures thereof. In certain crude oils, the naphthenic acids may include additional complex chemical structures with two, three, or four carboxylic groups, or with heteroatoms such as sulfur, oxygen, and nitrogen.
“Liquid Hourly Space Velocity” (LHSV) is the ratio of the hourly volume of oil processed to the volume of catalyst. It is generally expressed as v/v/hr or hr⁻¹. As such, LHSV, controls the residence time of the liquid reactants in typically cylindrical reactors.
“Silica gel” is silicon dioxide (SiO₂). It is a naturally occurring mineral that is purified and processed into either granular or beaded forms. Commercially available silica gels are provided with varying nominal pore sizes from about 24 angstroms (Å) to about 300 Å.
“Nominal pore size” is an average pore size measured by the Brunauer, Emmett and Teller (BET) nitrogen adsorption/desorption equation.
“Calcining” refers to heating of inorganic materials to a high temperature, but without fusing, in order to drive off volatile matter or to effect changes (such as oxidation or pulverization).
A “refinery” refers to an industrial plant that refines crude oil into petroleum products such as diesel, gasoline and heating oils.
A “continuous reactor” refers to a reactor that carries reactant materials as a flowing stream. Reactants are continuously fed into the continuous reactor and the products emerge as a continuous flow from the continuous reactor.
A “batch reactor” refers to a reactor where reactants are charged to the batch reactor and the reaction proceeds with time. A batch reactor usually does not reach a steady state, and control of temperature, pressure and volume is often needed. Thus, a batch reactor has ports for sensors and material input and output.
A “fixed bed reactor” is a cylindrical tube filled with catalyst pellets with reactants flowing through the bed of the catalyst pellets and being converted into products. The fixed bed reactor may have multiple configurations, including: one large bed, several horizontal beds, several parallel packed tubes, or multiple beds in their own shells.
“Associated gas” refers to a form of natural gas with a high content of higher hydrocarbons, and it is commonly found associated with deposits of petroleum.
“Straight-run feed” refers to a liquid hydrocarbon involving or produced in the course of petroleum refining by fractionation essentially without cracking or other pyrolytic change.

### DETAILED DESCRIPTION

The process can be used on any liquid hydrocarbon having an initial TAN greater than what is needed or preferred in downstream operations. Different liquid hydrocarbons with high initial TANs can include one or more of mineral crude oils, synthetic crude oils, distillate products, straight run feeds, atmospheric distillation bottoms, vacuum distillation bottoms, vacuum gas oils, and biologically-derived oils. The contacting reduces the initial

TAN by at least 20%, e.g., from about 21% to about 95% in the contacted feed oil. In one embodiment, the contacting reduces the initial TAN by greater than 40%.

In one embodiment, the liquid hydrocarbon is selected from the group consisting of a mineral crude oil, a synthetic crude oil, a distillate product, a straight-run feed, an atmospheric distillation bottom, a vacuum distillation bottom, a vacuum gas oil, a biologically-derived oil, and mixtures thereof.

The end TAN of the contacted feed oil is at least 20% less than the initial TAN of the liquid hydrocarbon. In one embodiment, for example, the initial TAN can be 20 mg KOH/g or greater and an end TAN after the contacting can be 15.5 mg KOH/g or less. In another embodiment, the initial TAN can be 1.5 mg KOH/g or greater and the end TAN after the contacting can be 1.0 mg KOH/g or less. In yet a third embodiment, the initial TAN can be from 2.0 to 10 mg KOH/g and an end TAN after the contacting can be from 0.1 to 7.8 mg KOH/g.

The contacting occurs at a low contacting temperature, from 200° C. to 300° C. The low contacting temperature can provide several advantages. One advantage is that the process can be implemented in a process unit, such as a refinery or stand-alone unit, without employing a heater or a furnace prior to the contacting. Heaters and furnaces are expensive equipment that can be especially prone to naphthenic acid corrosion. In one embodiment, no additional heating of the liquid hydrocarbon is provided prior to the contacting. In one embodiment, the liquid hydrocarbon is directly sent from another process unit that is not a heater or furnace, and a temperature of the liquid hydrocarbon feed from the another process unit is at the low contacting temperature.

The low contacting temperature reduces the rate of any corrosion in the process unit, such that less expensive materials of construction can be used for the process. For example, in some applications high alloy metals are not required. In one embodiment, the process reduces or eliminates naphthenic acids in the liquid hydrocarbon feed and no metallurgy upgrade or protective coating of the equipment being used is required to implement or perform the process.

The contacting is done without any addition of a hydrogen. Earlier catalysts have required significant amounts of added hydrogen and used hydrotreating or catalytic hydrogenation to reduce the TAN of high TAN liquid hydrocarbons. Hydrogen is typically in short supply, can be very expensive, and the equipment used to provide the hydrogen is expensive and bulky. Processes that don't require addition of hydrogen are preferred and needed.

In one embodiment, the process can be performed in a refinery and the process unit that performs the process can be placed before any heaters or furnaces. Heaters and furnaces can be used in subsequent processing steps such as distillations, hydrocracking, hydroisomerizing, hydrofinishing, catalytic cracking, or hydrotreating; and these heaters and furnaces, as well as the equipment used in the subsequent processing steps, are protected from excessive corrosion that would have been caused by handling high TAN hydrocarbons.

The ternary catalyst comprises a titanium oxide, a metal promoter, and a porous support. Examples of titanium oxides are titanium oxide (TiO), titanium dioxide (TiO2), ditatanium trioxide (Ti2O3), and trititanium pentoxide (Ti3O5). In one embodiment, the titanium oxide is titanium dioxide. In one embodiment the titanium oxide is not doped with another metal oxide. In one embodiment, the ternary catalyst comprises no metal titanate having an MTiO₃ structure, where M is a second metal having a valence of 2+.

In one embodiment, the ternary catalyst has a molar ratio of a titanium to a metal from the metal promoter that is greater than 3:1. In one embodiment, the ternary catalyst has the molar ratio that is from 4:1 to 100:1; and the ternary catalyst can additionally comprise a silicon to a titanium second molar ratio from 2:1 to 10:1; and also can comprise no metal titanate having an MTiO3 structure, where M is a second metal having a valence of 2+.

The metal promoter can be any metal that contributes to the TAN reduction in the liquid hydrocarbon. Examples of metal promoters can include an iron, a cobalt, a nickel, a copper, a zinc, a calcium, a magnesium, and combinations thereof. In one embodiment the metal promoter is an iron, a calcium, or a mixture thereof. In one embodiment, the metal promoter is not a metal oxide.

In one embodiment, the ternary catalyst comprises a molar ratio of a titanium to a metal from the metal promoter greater than 2:1, such as from 4:1 to 100:1.

The ternary catalyst comprises a porous support. Examples of porous supports include silica, alumina, silica-alumina, carbon, molecular sieves, and mixtures thereof. In one embodiment, the porous support comprises a silica, an alumina, a silica-alumina, or a mixture thereof. In one embodiment, the porous support has a nominal pore size greater than 30 Å, such as from 40 to 150 Å.

In one embodiment, the ternary catalyst comprises a second molar ratio of a silicon to a titanium greater than 1:1, such as from 2:1 to 10:1.

In one embodiment, the ternary catalyst is TiO₂—Ca—SiO₂ or TiO₂—Fe—SiO₂.

The ternary catalyst can be made by any means known by those skilled in the art. For example, the ternary catalyst can be made by an incipient wetness impregnation of the porous support or by thermal spraying. Incipient wetness impregnation is a commonly used technique for the synthesis of heterogeneous catalysts. In one embodiment, active metal precursors are dissolved in an aqueous or organic solution. Then the metal-containing solution is added to the porous support containing approximately the same pore volume as the volume of the metal-containing solution that was added. Capillary action draws the metal-containing solution into the pores of the porous support. Metal-containing solution added in excess of the porous support pore volume can cause the solution transport to change from a capillary action process to a diffusion process, which can be much slower. The ternary catalyst can then be dried and calcined to drive off the volatile components within the metal-containing solution, depositing the metal on the porous support. The maximum loading of the titanium oxide and the metal promoter can be limited by the solubility of the precursors in the metal-containing solution. The concentration profile of the impregnated compound depends on the mass transfer conditions within the pores during impregnation and drying.

In one embodiment, the active metal precursor for the titanium oxide is one or more titanium ethoxides. In one embodiment, the active metal precursor for the metal promoter is a metal nitrate hydrate.

In one embodiment, the active metal precursors are dissolved into an alcohol. Examples of alcohols that can be used include methanol, ethanol, isopropyl alcohol, butanol, pentanol, hexadecane-1-ol, and mixtures thereof.

In one embodiment, the ternary catalyst is prepared by dissolving titanium ethoxides and metal nitrate hydrates into an alcohol solution, and impregnating the titanium oxide and the metal promoter onto the porous support by an incipient wetness of the alcohol solution onto the porous support.

The volume of the metal-containing solution used for the incipient wetness impregnation can be adjusted to give the optimal capillary action and concentration profiles for the titanium oxide and the metal promoter on the porous support.

In one embodiment, the ternary catalyst is prepared by the incipient wetness impregnation followed by a drying step. The drying can be done by heating, by vacuum treating, by nitrogen flushing, or by a combination thereof. In one embodiment, the ternary catalyst is prepared by calcining. The calcining can be done before drying or after drying. The calcining can convert the metal precursors into their active forms and drive off any remaining liquid solution from an incipient wetness impregnation or thermal spraying. In one embodiment the ternary catalyst is calcined in air. In one embodiment, the ternary catalyst is calcined in an atmosphere comprising oxygen at a calcination temperature from 400 to 900° C. for 0.50 to 10 hours.

The contacting occurs quickly and efficiently. For example, the contacting can occur over less than two hours in a batch reactor, such as from 10 minutes to 119 minutes. In a continuous reactor, the contacting can occur at a LHSV from 0.5 hr-1 to 10 hr-1. Examples of two types of continuous reactors are fixed bed reactors and slurry bed reactors. In one embodiment, the contacting occurs in a fixed bed reactor or a slurry bed reactor. The continuous reactors can comprise a single catalyst bed or multiple catalyst beds. In one embodiment, the liquid hydrocarbon is passed over the ternary catalyst in a reactor operating in a continuous mode. Either an upflow or a downflow contacting reactor can be used. In one embodiment, the liquid hydrocarbon is passed over a monolithic catalyst in a contacting reactor operated in a continuous mode.

Monolithic catalysts have extruded substrates. Their porous support consists of many parallel channels separated by thin walls that are coated with the titanium oxide and the metal promoter. The channels in the monolithic catalyst may be round or polygonal (mainly square or hexagonal). The structure of monolithic catalysts is reminiscent of a honeycomb. Their cell density may be from 30 to 200/cm² with the separating walls from 0.05 to 0.3 mm thick. Because of a high open frontal area (the open spaces in the cross-sectional area) of 72 to 87% pressure loss of fluids flowing through the monolithic catalyst structure is low, which can be an important feature to minimize efficiency losses.

In one embodiment, a contacting pressure during the contacting is from 70 to 1000 kPa. In some embodiments, the contacting pressure during the contacting may be the same as what is used in adjacent equipment, so as to minimize the number and amount of pressure adjustments. In one embodiment, a blower or compressor is used to raise a lower pressure of the liquid hydrocarbon feed to the desired contacting pressure. In one embodiment, the contacting pressure during the contacting may be less than a subsequent pressure used in downstream operations. In some embodiments, it may be necessary to pump the contacted feed oil to the higher subsequent pressure.

In one embodiment, the contacted feed oil is sent to a subsequent refining operation. In one embodiment, the contacted feed oil is sent to a downstream fluid catalytic cracking (FCC) unit or a downstream hydroprocessing unit. Examples of downstream hydroprocessing units include hydroisomerization reactors, hydrocracking units, hydrotreating units, and hydrofinishing units. The products of petroleum refining must meet tight specifications, for example they can have limits on sulfur, nitrogen, olefins, aromatics, and other contaminants, as well as limits on cold flow properties, octane number, and kinematic viscosity. Hydrotreating removes contaminants from distilled crude oil fractions and intermediate process streams. Hydrocracking converts heavy oil fractions into lighter, more valuable products. Hydrotreating and hydrocracking processes share many common features, so they often are discussed together as “hydroprocessing.” Most hydroprocessing units employ specialized catalysts. As the name implies, they all consume hydrogen. Important chemical reactions that occur during hydroprocessing can include hydrodesulfurization (HDS), hydrodenitrogenation (HDN), hydrodeoxygenation, the saturation of olefins and aromatics, and hydroisomerization. In one embodiment, the downstream hydroprocessing unit may comprise more than one reactor or perform more than one chemical reaction.

In one embodiment, the contacting occurs with a flow of a stripping gas. Examples of stripping gases that could be used include inert gases such as nitrogen, helium, neon, and argon. Other stripping gases that could be used include refinery gas or associated gas. The flow of the stripping gas can be used to strip carbon dioxide, water vapor, and other light gases from the reactor used for the contacting. In one embodiment, a blower or a compressor can be used to feed an optional low pressure stripping gas stream to the reactor used for the contacting. In one embodiment, the flow of the stripping gas can be countercurrent to the flow of the liquid hydrocarbon feed through the reactor used for the contacting. In one embodiment, the flow of the stripping gas is from 50 to 200 scf/bbl (standard cubic feet of gas per barrel) of the liquid hydrocarbon feed.

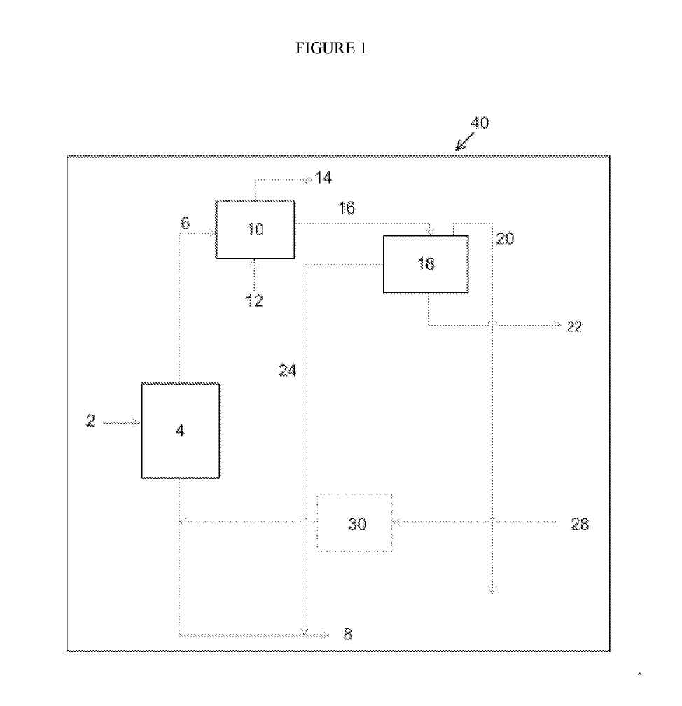

One example of a TAN reduction unit (40) is shown in FIG. 1. As shown in FIG. 1, a liquid hydrocarbon feed (2) with a high initial TAN is fed to a reactor (4) comprising the ternary catalyst. The reactor (4) is a continuous reactor. The reactor (4) is fluidly connected to a condenser (10) that receives light hydrocarbons (6) that are eluted from the reactor (4). The reactor (4) separately elutes a contacted feed oil (8). The contacted feed oil (8) has an end TAN at least 20% less than the initial TAN of the liquid hydrocarbon feed (2). The contacted feed oil (8) is much more suitable for subsequent processing than the liquid hydrocarbon feed (2). The light hydrocarbons (6) contains various components, such as carbon dioxide, methane, carbon monoxide, water vapor, and other light hydrocarbons. The condenser (10) utilizes a coolant (12) that is passed through it and the used coolant (14) is removed from the condenser (10). An example of a coolant (12) that could be used is coolant water. A mixed stream (16), which has been cooled, from the condenser (10) is sent and received by a three-phase separator (18), that is fluidly connected to the condenser (10). The three-phase separator (18) separates the mixed stream (16) into a gas stream (20), a water stream (22) and a light ends stream (24). The gas stream (20), the water stream (22), and the light ends stream (24) are removed from the three-phase separator (18). The gas stream (20) may be further processed separately. The light ends stream (24) is passed through a connection between the three-phase separator (18) and a line from the reactor (4) that combines the light ends stream (24) with the contacted feed oil (8). Optional features are shown in the FIG. 1, including a stripping gas stream (28) that is fed to the reactor (4). A blower or compressor (30) can be used to feed the stripping gas stream (28) that has a lower pressure to the reactor (4). The stripping gas stream (28) can serve to strip carbon dioxide, water vapor, and other light gases from the reactor (4).

The TAN reduction unit can be used, for example, within a crude oil refinery. The process is useful for pretreating high TAN crude oils prior to further processing and thus avoids corrosion of equipment used in the refining. The TAN reduction unit (40) can be located at one or more locations in the refinery, such as before a heater or furnace, after a heater or furnace, or placed in one or more locations to treat various fractions from a distillation column. Fractions from a distillation column that could be treated include distillation bottoms, base oil fractions, gas oil fractions, diesel fractions, kerosene fractions, naphtha fractions, and vacuum gas oil (VGO) fractions.

The transitional term “comprising”, which is synonymous with “including,” “containing,” or “characterized by,” is inclusive or open-ended and does not exclude additional, un-recited elements or method steps. The transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention.

For the purposes of this specification and appended claims, unless otherwise indicated, all numbers expressing quantities, percentages or proportions, and other numerical values used in the specification and claims, are to be understood as being modified in all instances by the term “about.” Furthermore, all ranges disclosed herein are inclusive of the endpoints and are independently combinable. Whenever a numerical range with a lower limit and an upper limit are disclosed, any number falling within the range is also specifically disclosed. Unless otherwise specified, all percentages are in weight percent.

Any term, abbreviation or shorthand not defined is understood to have the ordinary meaning used by a person skilled in the art at the time the application is filed. The singular forms “a,” “an,” and “the,” include plural references unless expressly and unequivocally limited to one instance.

All of the publications, patents and patent applications cited in this application are herein incorporated by reference in their entirety to the same extent as if the disclosure of each individual publication, patent application or patent was specifically and individually indicated to be incorporated by reference in its entirety.

This written description uses examples to disclose the invention, including the best mode, and also to enable any person skilled in the art to make and use the invention. Many modifications of the exemplary embodiments of the invention disclosed above will readily occur to those skilled in the art. Accordingly, the invention is to be construed as including all structure and methods that fall within the scope of the appended claims. Unless otherwise specified, the recitation of a genus of elements, materials or other components, from which an individual component or mixture of components can be selected, is intended to include all possible sub-generic combinations of the listed components and mixtures thereof.

The invention illustratively disclosed herein suitably may be practiced in the absence of any element which is not specifically disclosed herein.

### EXAMPLES

### Example 1

### Preparation of Ternary Catalysts

A calculated amount of titanium ethoxides (source of titanium) and metal nitrate hydrates (sources of Ca or Fe promoters) were dissolved into ethanol. The metal nitrate hydrates were Fe(NO₃)₃.9H₂O or Ca(NO₃)₂.4H₂O. The volume of ethanol was based on the water pore volume of porous 60 Å silica gel supports. After incipient wetness impregnation, the resulting catalyst precursors on the porous supports were dried overnight at 120° C. in a vacuum oven. The dried catalysts were calcined at 500° C. in air for three hours. The ternary catalysts had the following elemental compositions and elemental molar ratios:

TiO₂—Ca—SiO₂ (Ti/Ca=17.9, Si/Ti=7.4) Ternary Catalyst A

TiO₂—Ca—SiO₂ (Ti/Ca=4.8, Si/Ti=9.1) Ternary Catalyst B

TiO₂—Fe—SiO₂ (Ti/Fe=49.6, Si/Ti=6.6) Ternary Catalyst C

### Example 2

### Batch Testing of TAN Reduction

The ternary catalysts prepared in Example 1, as well as comparative test catalysts, were batch tested on four different hydrocarbon feeds:
1) A model hydrocarbon feed having an initial TAN of 20 mg KOH/g. The model hydrocarbon feed was a mixture of mineral crude oil derived naphthenic acids (obtained from Merichem Company, Houston, Tex.) and a naphthenic white oil (HR Tufflo 1200, obtained from Calument Specialty Products Partners L.P., Indianapolis, Ind.).
2) A vacuum gas oil (VGO) having an initial TAN of 6.14 mg KOH/g.
3) A Bressay mineral crude oil from the United Kingdom North Sea having a TAN of 9.63 mg KOH/g.
4) An Albacora mineral crude oil from Brazil having an initial TAN of 1.97 mg KOH/g.

The comparative test catalysts were silica (SiO2) and titanium dioxide on silica (TiO2-SiO2). A control test without any catalyst was also performed.

The batch testing was done in a batch testing unit, under a nitrogen gas flow of approximately 50 ml/min. The batch testing unit was a 50 ml round bottom flask equipped with a glass coated magnetic stirrer, a heating mantle, and a condenser (using dry ice) to minimize evaporative losses. The four different hydrocarbon feeds were mixed with 5 wt % of the various test catalysts and heated to a contacting temperature using the heating mantle over 30 to 40 minutes. The contacting temperature was either 275° C. or 300° C. Once the contacting temperature was reached, the batch testing unit was maintained at the contacting temperature for one hour.

Catalytic activity for TAN reduction was measured in real time by the evolution of carbon dioxide, and at the conclusion of the reaction by measurement of the end TAN. The results of the batch tests on the model hydrocarbon feed are shown in Table I. The results on the other hydrocarbon feeds using Ternary Catalyst C are shown in Table II.

TABLE I
Batch Tests with Model Hydrocarbon Feed

| | | 275° C. | | 300° C. | |
|---|---|---|---|---|---|
| | Initial | End | % TAN | End | % TAN |
| | TAN | TAN | Reduction | TAN | Reduction |
| Control-No | 20 | — | — | 24.4 | (−22)* |
| Catalyst | | | | | |
| SiO₂ | 20 | — | — | 16.59 | 17 |
| TiO₂—SiO₂ | 20 | 15.95 | 20 | 13.47 | 33 |
| Ternary | 20 | 15.33 | 23 | 13.91 | 30 |
| Catalyst A | | | | | |
| Ternary | 20 | 15.52 | 22 | 13.89 | 31 |
| Catalyst B | | | | | |
| Ternary | 20 | 14.87 | 26 | 13.30 | 34 |
| Catalyst C | | | | | |

*TAN increase was possibly due to inadequately controlled evaporative weight loss.

TABLE II
Batch Tests on Other Hydrocarbon Feeds with Ternary Catalyst C

| | | | Control - | | Ternary | |
|---|---|---|---|---|---|---|
| | | Contacting | No Catalyst | | Catalyst C | |
| Hydrocarbon | Initial | Temperature, | End | % TAN | End | % TAN |
| Feed | TAN | ° C. | TAN | Reduction | TAN | Reduction |
| VGO | 6.14 | 275 | 4.8 | 22 | 3.49 | 43 |
| | 6.14 | 300 | 3.9 | 36 | 2.75 | 55 |
| Bressay | 9.63 | 275 | — | — | 6.95 | 28 |
| Crude Oil | 9.63 | 300 | 7.48 | 22 | 7.1 | 26 |
| Albacora | 1.97 | 275 | — | — | 0.29 | 85 |
| Crude Oil | | | | | | |

The batch testing demonstrated the improved efficacy of the ternary catalysts for reducing the TAN of various hydrocarbon feeds.

It is claimed:

1. A process for reducing a TAN of a liquid hydrocarbon, comprising contacting, without addition of a hydrogen, the liquid hydrocarbon having an initial TAN from 0.5 to 150 mg KOH/g with a ternary catalyst comprising a titanium-oxide, a metal promoter, and a porous support; wherein the contacting occurs over less than two hours or at a LHSV from 0.5 hr⁻¹ to 10 hr⁻¹, wherein the contacting occurs at a contacting temperature from 200° C. to 300° C., and wherein the contacting reduces the initial TAN by at least 20% in a contacted hydrocarbon.

2. The process of claim 1, wherein the liquid hydrocarbon is selected from the group consisting of a mineral crude oil, a synthetic crude oil, a distillate product, a straight-run feed, an atmospheric distillation bottom, a vacuum distillation bottom, a vacuum gas oil, a biologically-derived oil, and mixtures thereof.

3. The process of claim 1, wherein the ternary catalyst comprises a molar ratio of a titanium to a metal from the metal promoter from 4:1 to 100:1.

4. The process of claim 1, wherein the ternary catalyst comprises a second molar ratio of a silicon to a titanium from 2:1 to 10:1.

5. The process of claim 1, wherein the ternary catalyst comprises no metal titanate having an MTiO₃ structure, where M is a second metal having a valence of 2+.

6. The process of claim 1, wherein the ternary catalyst is TiO₂—Ca—SiO₂ or TiO₂—Fe—SiO₂.

7. The process of claim 1, wherein the ternary catalyst is made by an incipient wetness impregnation of the porous support.

8. The process of claim 1, wherein the metal promoter is an iron, a calcium, or a mixture thereof.

9. The process of claim 1, wherein the ternary catalyst is prepared by dissolving titanium ethoxides and metal nitrate hydrates into an alcohol solution, and impregnating the titanium-oxide and the metal promoter onto the porous support by an incipient wetness of the alcohol solution onto the porous support.

10. The process of claim 1, wherein the ternary catalyst is prepared by calcining in air.

11. The process of claim 1, wherein the porous support comprises a silica, an alumina, a silica-alumina, or a mixture thereof.

12. The process of claim 1, wherein the porous support has a nominal pore size from 40 to 150 Å.

13. The process of claim 1, wherein the contacting reduces the initial TAN by greater than 40%.

14. The process of claim 1, wherein the contacting occurs with a flow of a stripping gas.

15. The process of claim 1, wherein a contacting pressure during the contacting is from 70 to 1000 kPa.

16. The process of claim 1, wherein the contacted hydrocarbon is sent to a downstream FCC unit or a downstream hydroprocessing unit.

17. The process of claim 1, wherein the contacting occurs in a fixed bed reactor or a slurry bed reactor.

18. The process of claim 1, wherein the liquid hydrocarbon is directly sent from another process unit that is not a heater or a furnace, and a temperature of the liquid hydrocarbon from the another process unit is at the contacting temperature.

19. A ternary catalyst that reduces a TAN of a liquid hydrocarbon at a contacting temperature from 200° C. to 300° C., comprising: a titanium dioxide; a metal promoter that is not an oxide, wherein the metal promoter comprises an iron, a calcium, or a combination thereof; and a porous support comprising a silica, an alumina, a silica-alumina, or a mixture thereof, wherein the ternary catalyst has a molar ratio of a titanium to a metal from the metal promoter that is greater than 3:1.

20. The ternary catalyst of claim 19, wherein the molar ratio is from 4:1 to 100:1; additionally, comprising a silicon to a titanium second molar ratio from 2:1 to 10:1; and comprising no metal titanate having an MTiO₃ structure, where M is a second metal having a valence of 2+.

21. The ternary catalyst of claim 20, wherein the ternary catalyst is TiO₂—Ca—SiO₂ or TiO₂—Fe—SiO₂.
